(19) United States
(12) Patent Application Publication
(10) Pub. No.: US 2006/0135233 A1
(43) Pub. Date: Jun. 22, 2006

(54) System and method for managing advertising content delivery in an on-line gaming environment

(76) Inventors: Daniel Willis, Stittsville (CA); Dhananjay Godse, Kanata (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/303,970

(22) Filed: Dec. 19, 2005

Related U.S. Application Data
(60) Provisional application No. 60/636,543, filed on Dec. 17, 2004.

(51) Int. Cl. A63F 13/00

(52) U.S. Cl. 463/1

(57) ABSTRACT

A method for managing advertising content delivery in a gaming environment that is in execution on an online enabled platform includes initiating an instance of a game, and fetching a piece of advertising content from an advertising service provider via a communications network. During a gaming session, at least one impression for the piece of advertising content is provided. At a time, the game instance provides an indication of the at least one impression to a server of an advertising broker site via the communications network. The advertising broker site updates a current impressions count based on the provided indication.

### REFERENCE TO PRIOR APPLICATION

This application claims benefit from U.S. Provisional application 60/636,543 filed on Dec. 17, 2004, the entire contents of which is incorporated herein by reference.

### FIELD OF THE INVENTION

The instant invention relates generally to providing advertising content via the Internet, and more particularly to systems and methods for managing advertising content delivery in an on-line gaming environment.

### BACKGROUND OF THE INVENTION

During recent years, computer gaming has gained increasing popularity, and today thousands of players are playing all around the world. Predictably, interactive computer gaming has blurred the line between games and other entertainment or communication media, and the avenues explored in the development of gaming might well break new ground for interactive Internet applications in all areas of business relations and social life.

Due to their dynamic nature and specific appeal to certain audiences, computer games and especially games played on Internet enabled platforms provide the ideal vehicle for Internet advertising. Not only is it possible for an advertiser to directly target a specific group of customers, but also advertisements can be directly incorporated into the computer games, enabling something similar to the well-known concept of product placement. It would therefore be highly advantageous to have at hand a system for effectively combining the two concepts elucidated above, and thus building a bridge from the advertising world to the world of computer gaming.

### SUMMARY OF THE INVENTION

It is an object of at least one embodiment of the instant invention to link advertising sites with gaming sites to allow for specific and dynamic combinations of targeted advertisements with a proper advertising environment.

In accordance with an aspect of the instant invention there is provided a method for managing advertising content delivery in a gaming environment, comprising: providing at least a server connected to a communications network; maintaining on the at least a server a count of impressions served for known advertising content; receiving at the at least a server a current impression count request, the request relating to the known advertising content; providing from the at least a server, data relating to a current count of impressions served for the known advertising content; and, based on the provided current count of impressions served, determining whether a specified impression cap has been reached for the known advertising content.

In accordance with an aspect of the instant invention there is provided a method for managing advertising content delivery in an gaming environment, comprising: providing at least a server connected to a communications network; maintaining on the at least a server a count of impressions served for known advertising content; receiving at the at least a server a request for availability data relating to the known content and relevant to a current game; providing from the at least a server the availability data; and, based on the provided availability data, determining whether the known advertising content is available to be displayed by the current game.

In accordance with an aspect of the instant invention there is provided a method for managing advertising content delivery in an gaming environment, comprising: initiating a game instance of an advertising enabled game; fetching a piece of advertising content from an advertising service provider (ADSP) via a communications network; providing at least one impression for the piece of advertising content during a game instance; at a time, providing an indication of the at least one impression from the game instance to an advertising broker site via the communications network; and, based on the provided indication, updating a current impressions count being maintained for the piece of advertising content by the advertising broker site.

In accordance with an aspect of the instant invention there is provided a method for managing advertising content delivery in an gaming environment, comprising: initiating a game instance of an advertising enabled game; fetching a piece of advertising content from an advertising service provider (ADSP) via a communications network; providing at least one impression for the piece of advertising content during a game instance; at a time, providing an indication of the at least one impression from the game instance to a server via the communications network; and, based on the provided indication, updating a current impressions count being maintained for the piece of advertising content on the server.

In accordance with an aspect of the instant invention there is provided a system for managing advertising content delivery in a gaming environment that is in execution on an online enabled platform, the gaming environment including a plurality of game instances each containing therein spots for displaying advertising content, the system comprising: a plurality of advertising service providers (ADSPs) each for communicating with a plurality of game instances via the communications network, the ADSPs for making advertising content available for display at spots within the plurality of game instances, the advertising content having predetermined availability characteristics; and, an advertising broker site in communication with the plurality of game instances and with the plurality of ADSPs via the communications network, the advertising broker site for storing data that is relevant to the predetermined availability characteristics of the advertising content, and for updating the stored data based on usage reports provided from the plurality of game instances via the communications network.

In accordance with an aspect of the instant invention there is provided a broker mediated advertisable gaming environment having gaming sites and advertising sites connected to an Internet protocol wide area network. The gaming environment comprises a broker site connected to the Internet protocol wide area network for registering games provided from gaming sites and for licensing registered games for advertising to advertising sites, whereby the broker site maintains an inventory of characteristics of registered games, the characteristics relevant for advertising.

In accordance with another aspect of the instant invention there is provided a method for allowing an advertiser to group content and spots as part of an ad campaign.

In accordance with another aspect of the instant invention there is provided a method for allowing an advertiser to specify a presentation cap for an ad campaign.

In accordance with another aspect of the instant invention there is provided a method for tracking, aggregating and reporting back to an advertising service provider the total number of presentations per content.

In accordance with another aspect of the instant invention there is provided a method for allowing an advertising service provider to determine whether content is to be distributed to new game instances, based on whether a campaign cap is being approached or has been exceeded.

In accordance with another aspect of the instant invention there is provided a method for allowing the frequency of presentations to be tracked by the game instance.

In accordance with another aspect of the instant invention there is provided a method for allowing a game instance to stop presenting content once a client-side constraint is met.

In accordance with another aspect of the instant invention there is provided a method wherein the number of presentations recorded by the client reflects the actual number of times the ad is presented within the game.

In accordance with another aspect of the instant invention there is provided a method by which the presentation data is submitted to the broker for aggregation to facilitate billing.

In accordance with another aspect of the instant invention there is provided a method by which a presentation schedule is created based on the various ads to be displayed and their client-side constraints.

In accordance with another aspect of the instant invention there is a provided a method for allowing an advertiser to schedule content on standby. Standby content being delivered to the games for presentation when there is space allowed due to frequency caps being reached.

### BRIEF DESCRIPTION OF THE DRAWINGS

Embodiments of the instant invention will now be described in conjunction with the following drawings, in which:

FIG. 1 is a schematic block diagram showing an on-line advertisable gaming environment;

FIG. 2a is a schematic block diagram showing an on-line broker mediated advertisable gaming environment;

FIG. 2b is a simplified flow diagram showing one scheme for communication between the elements of the on-line advertisable gaming environment of FIG. 2a;

FIG. 2c is a simplified flow diagram showing another scheme for communication between the elements of the on-line advertisable gaming environment of FIG. 2a;

FIG. 3 is a simplified flow diagram of a method for selecting an advertising service provider;

FIG. 4 is a simplified flow diagram of a method according to an embodiment of the instant invention;

FIG. 5 is a simplified flow diagram of another method according to an embodiment of the instant invention;

FIG. 6 is a simplified flow diagram of yet another method according to an embodiment of the instant invention; and,

FIG. 7 is a simplified flow diagram of still another method according to an embodiment of the instant invention.

### DETAILED DESCRIPTION OF EMBODIMENTS OF THE INVENTION

In an on-line advertisable gaming environment an advertiser provides advertising content for display to a client, specifically an on-line gamer. An advertising service provider (ADSP) facilitates this process by making available advertisements to fill spots within a game instance for presenting the advertising content to the client. Each time advertising content is presented within a spot, an impression is counted. As part of a larger ad campaign, the advertiser optionally groups together different content and different spots, and optionally the spots are spread across more than one game platform. As is common in conventional forms of advertising, the ad campaign usually includes specified financial and time constraints.

Once an ad campaign is established, it is the responsibility of the ADSP to ensure that it is efficiently implemented. For a variety of reasons, often it is desirable to control the amount of exposure of a particular ad to an individual client to a population. For instance, an advertiser optionally specifies a limit to the number of impressions during a given time period so as not to overwhelm the audience with its ads. There is usually also a budget to work within, so the advertiser optionally requests a limit to the number of impressions in order to stay within the allotted budget. These are just a few non-limiting examples of factors that affect the ADSP's ability to schedule content delivery. Another factor relates to the nature of the spots that are available within a game instance. For instance, certain spots are suitable for presenting only certain forms of advertising content. One example is an auto-racing game instance, in which the brand of an oil company advertiser is displayed within a label-shaped spot of an oil container that is used during a pit stop. Clearly, this label-shaped spot does not possess contextual characteristics that are appropriate for displaying it as an ad on items of snack food, etc.

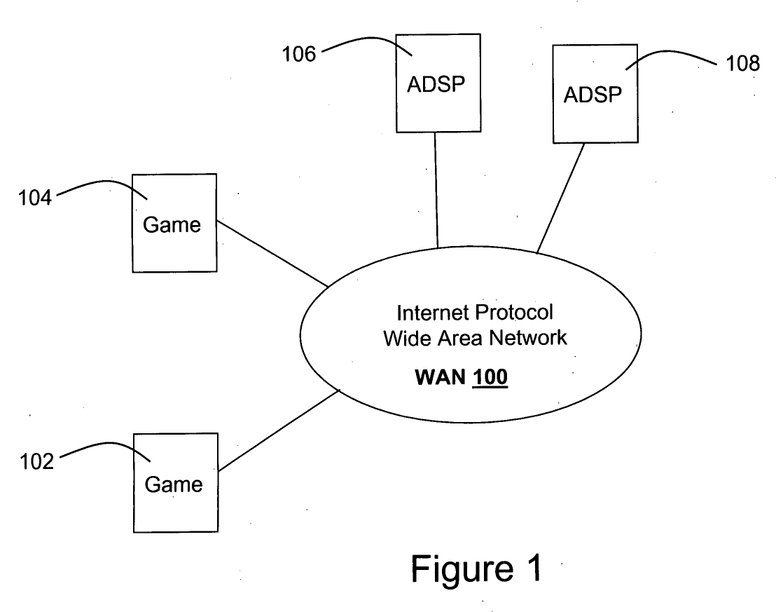

Referring now to FIG. 1, shown is a schematic block diagram of an on-line advertisable gaming environment. Games 102 and 104 are executed on game platforms connected to a communications network, such as for instance Internet Protocol Wide Area Network (WAN) 100. In the instant example, plural instances of game 102 or their associated gaming system communicate with and receive content from advertising service provider (ADSP) 106 via WAN 100. Similarly, plural instances of game 104 or their associated gaming system communicate with and receive content from ADSP 108 via WAN 100. Each one of ADSP 106 and ADSP 108 is assumed to implement one or more ad campaign at a time. In the case of plural ad campaigns, ADSP 106 and ADSP 108 are required to manage and schedule the delivery of content that is provided by different advertisers, to a limited number of available spots within instances of games 102 and 104, respectively.

In one specific example of a real-life situation, an advertiser sets a cap on the maximum number of impressions for a given ad campaign, where the ad campaign includes one or more different ads presented in one or more game spots within one or more games. Alternatively, the advertiser sets a specific cap for each different ad in the campaign. The ADSP must take steps to ensure that any caps set by the advertiser are respected at least in so far as billing to the advertiser. For example, during a gaming session each instance of game 102 fetches content from ADSP 106, generates and tracks impressions, and subsequently reports the impressions back to ADSP 106. In this way, ADSP 106 acquires impression frequency data relating to each advertiser's ad campaign. ADSP uses this data to maintain a current impressions count. Optionally, this count is further broken down on a per client basis, a per ad basis, etc. However, the task of preventing campaign caps from being exceeded is complicated by the fact that there is always a variable lag between a game instance fetching content, generating impressions and subsequently reporting the impressions. This lag often results in the campaign cap being exceeded, since the ADSP 106 is not aware that a cap has been met until all instances of a game session have reported their results, yet in the interim, the ADSP continues to provide content to new game instances. Dynamically modeling this lag, which varies both by game and by time and date, is one way to “dampen the system” and thereby reduce or prevent campaign cap overshoot.

Optionally, client-side constraints also are used to limit the impression frequency for individual clients. Further optionally, client-side constraints are specified on one or more of a: per time interval basis, per game basis, per session basis, per gamer basis, and per platform basis. Client-side constraints are fetched by a game instance along with the content. The game instance then resolves multiple client-side constraints associated with multiple pieces of provided content to determine which content to present in a given spot and at a given time. Optionally, an advertiser specifies that a fixed percentage of impressions are to be made to a gamer client, or the advertiser specifies that the impressions occur according a particular presentation schedule, both of which are also client-side constraints. Additionally, advertisers typically want to be assured that all impressions that are recorded are in fact impressions that are presented to actual gamers, as opposed to software (e.g., “bots”), which merely automatically invoke games and generate ad impressions. Client-side constraints help to mitigate this risk.

Advantageously, the impression frequency data that is acquired by an ADSP is useful for scheduling future impressions in order to maximize revenue and reduce financial liability relating to unfilled spots. One way to achieve these goals is to offer spots to additional advertisers on a standby basis. Standby content is used as a sort of filler material when regular ad campaign content is not available to fill a particular spot in a game instance. This is done for a number of different reasons. For instance, if an advertiser sets an impression cap for an ad campaign that is scheduled to run for three months and this cap is reached two weeks early, then the ADSP optionally provides standby content during the final two weeks of the ad campaign rather than absorb the cost of the unfilled spots. Optionally the standby impressions are offered on a break-even basis for the ADSP. Alternatively, if the impression frequency is higher than expected early in the ad campaign, then the ADSP has the option of interspersing some standby content with the regular content so as to stretch the same number of impressions over the entire duration of the ad campaign. Optionally, the ADSP begins interspersing small amounts of standby content early on in the ad campaign, or waits until the impression cap is nearly reached before interspersing a larger amount of standby content. Advertisers scheduling standby content may optionally specify that campaign caps associated with the content be satisfied before being available to additional other advertisers on a continued standby basis. Of course, under some circumstances standby content is provided even when an ad campaign is not on target to reach its cap, if for instance the advertiser has set additional caps for individual ads within the campaign, and if all ads that are suitable for being displayed in an available spot have already reached their individual cap. In such an instance, the ADSP provides standby content that is appropriate for being displayed in the available spot rather than accept the financial liability of allowing the spot to remain empty.

Alternatively, when there is no financial liability to exceeding a cap, the above noted method allows the ADSP to monetise the extra ad spots that would otherwise remain unpaid. As such, it is clearly advantageous to the ADSP to fill each spot with a paying advertisement.

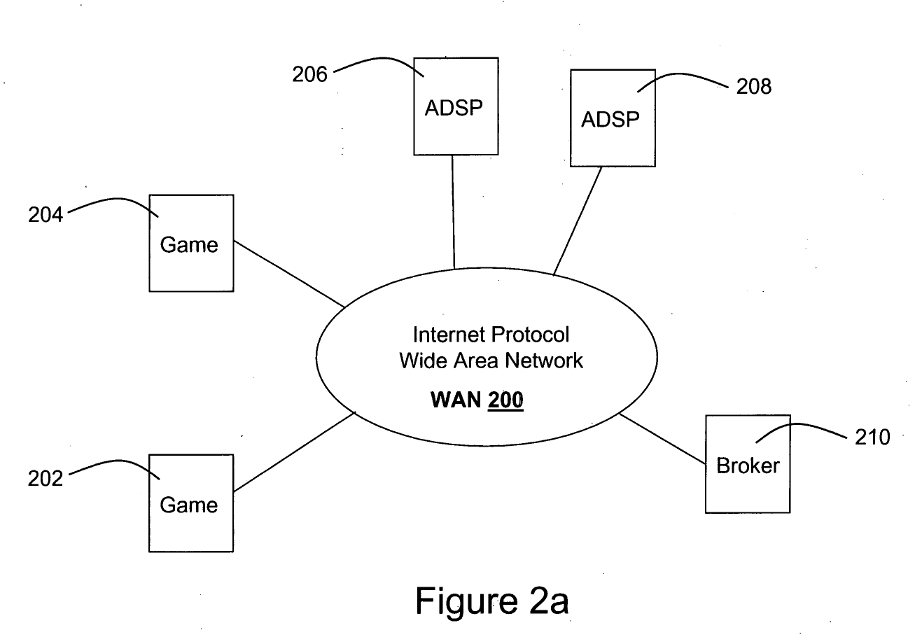

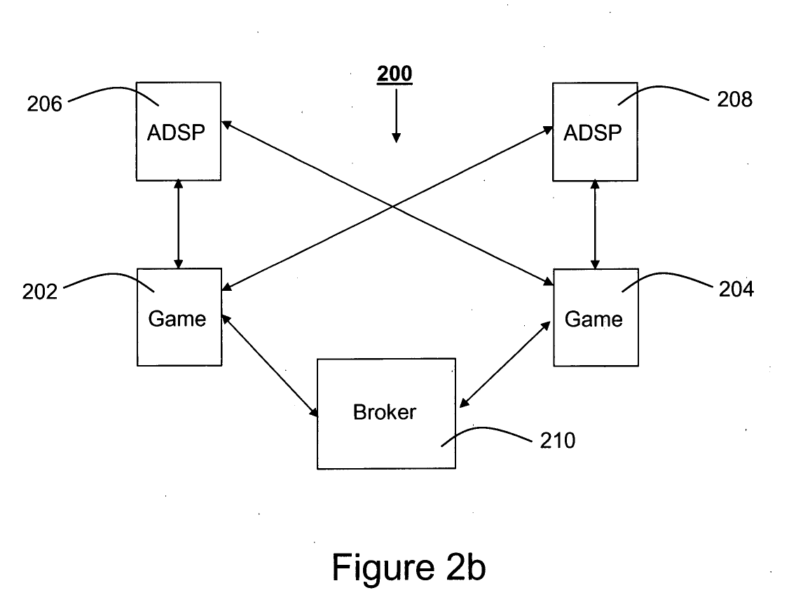

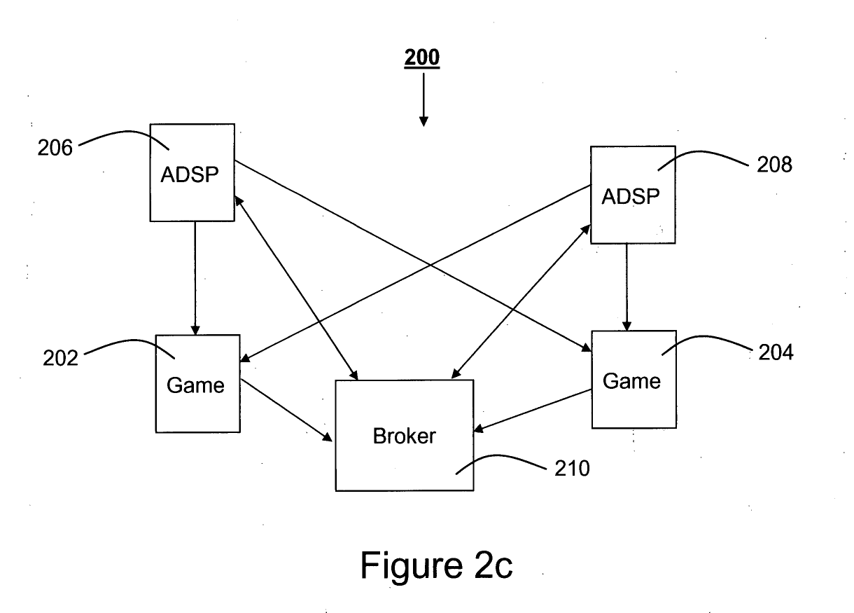

Referring now to FIG. 2a, shown is a high-level block diagram of a broker mediated advertisable gaming system according to an embodiment of the instant invention. Games 202 and 204 are connected to a communications network, such as for instance Internet Protocol Wide Area Network (WAN) 200. Advertising service providers (ADSP) 206 and 208 also are connected to WAN 200. Each one of ADSP 206 and ADSP 208 implements one or more ad campaign at a time. In the case of plural ad campaigns, ADSP 206 and ADSP 208 schedule the delivery of content that is provided by different advertisers, to a limited number of available spots within instances of games 102 and/or 104. To this end ADSP 206 and ADSP 208 “buy” blocks of spots within games 102 and 104, and then sell these spots to advertisers for displaying advertising content over a period of time. Typically, an advertiser sets a cap on the maximum number of impressions for a given ad campaign, where the ad campaign includes one or more different ads presented in one or more game spots. Alternatively, the advertiser sets a specific cap for each different ad in the campaign. Clearly, managing and scheduling content selected from a plurality of different advertising campaigns that are being implemented by a plurality of ADSPs, for delivery to a plurality of game instances of a plurality of games without exceeding advertiser imposed impression caps is a highly complex process. The process is facilitated by providing an advertising broker site 210 connected to WAN 200, as is discussed in greater detail below.

Referring now to FIG. 2b, shown is a simplified flow diagram of one communication scheme for being implemented by the system of FIG. 2a. The advertising broker site 210 is in communication via WAN 200 with game 202 and with game 204. Game 202 and game 204 are each in communication with ADSP 206 and with ADSP 208. When a game instance of game 202 or 204 begins, that game instance communicates via WAN 200 with the advertising broker site 210 to determine from which ADSP to retrieve content. The advertising broker site 210 communicates a response via WAN 200, including an indication of which ADSP the game instance is required to contact for content. Subsequent to the initial “handshake” with the advertising broker site 210, the game instance communicates with one or more indicated ADSPs and receives, via WAN 200, a list of content associated-with spots in the game instance. This communication scheme relies upon each ADSP maintaining a local current impressions count. The local current impression count is updated when a game instance communicates impression data to the ADSP. The impression data is communicated back to the ADSP at a predetermined time. For instance, during a previous gaming session each instance of games 202 and 204 enumerates the number of impressions of specific pieces of content. At the time a new game instance is initiated, the game instance establishes communication via WAN 200 with the ADSP that provided the specific content and reports the impression data relating to the previous gaming session. The number of impressions is then aggregated at the ADSP level, across all instances of games 202 and 204. In this way, each ADSP is able to maintain a current impressions count relating to an entire ad campaign and/or relating to each specific piece of content within a particular ad campaign. Then, for each specific piece of content relevant to the game instance, the indicated ADSP fetches the current impressions count associated therewith, and determines whether or not to include the content in the list that is reported back to game instance, based on whether a campaign cap is or is about to be exceeded. Of course, optionally the impression data is communicated back to the ADSP at a different predetermined time during which the game instance is connected to WAN 200. Some non-limiting examples include: during a current game instance after a predetermined number of impressions is served, during a current game instance after a predetermined amount of time has elapsed since a previous update was communicated, during a current game instance every time a gamer advances to a next level, during a current game instance any time the game is paused or suspended, during a current multi-player game instance whenever a new gamer joins, and at the end of a current game session prior to the game instance disconnecting from the WAN 200.

However, the task of preventing campaign caps from being exceeded is complicated by the fact that there is always a variable lag between a game instance fetching content, generating impressions and subsequently reporting the impressions. This lag often results in the campaign cap being exceeded, since the ADSP is not aware that a cap has been met until all instances of a game session have reported their results, yet in the interim, the ADSP continues to provide content to new game instances. Dynamically modeling this lag, which varies both by game and by time and date, is one way to “dampen the system” and thereby reduce or prevent campaign cap overshoot.

Optionally, client-side constraints also are used to limit the impression frequency for individual clients. Further optionally, client-side constraints are specified on one or more of a: per time interval basis, per game basis, per session basis, per gamer basis, and per platform basis. Client-side constraints are fetched by the game instance along with the content. The game instance then resolves multiple client-side constraints associated with multiple pieces of provided content to determine which content to present in a given spot at and at a given time. Optionally, an advertiser specifies that a fixed percentage of impressions are to be made to a gamer client, or the advertiser specifies that the impressions occur according a particular presentation schedule, both of which are also client-side constraints. Additionally, advertisers typically want to be assured that all impressions that are recorded are in fact impressions that are presented to actual gamers, as opposed to software (e.g., “bots”), which merely automatically invoke games and generate ad impressions. Client-side constraints help to mitigate this risk.

Advantageously, the current impressions count that is maintained by an ADSP is useful for scheduling future impressions in order to maximize revenue and reduce financial liability relating to unfilled spots. One way to achieve these goals is to offer spots to additional advertisers on a standby basis. Standby content is used as a sort of filler material when regular ad campaign content is not available to fill a particular spot in a game instance. This is done for a number of different reasons. For instance, if an advertiser sets an impression cap for an ad campaign that is scheduled to run for three months and this cap is reached two weeks early, then the ADSP optionally enables standby content for inclusion in the list reported back to game instance, rather than absorb the cost of the unfilled spots. Optionally the standby impressions are offered on a break-even basis for the ADSP. Alternatively, if the impression frequency is higher than expected early in the ad campaign, then the ADSP optionally enables standby content for inclusion in the list reported back to game instance, to be interspersed with the regular content so as to stretch the same number of impressions over the entire duration of the ad campaign. The ADSP optionally begins interspersing small amounts of standby content early on in the ad campaign, or alternatively waits until the impression cap is nearly reached before interspersing a larger amount of standby content. Advertisers scheduling standby content may optionally specify that campaign caps associated with the content be satisfied before being available to additional other advertisers on a continued standby basis. Of course, under some circumstances standby content is provided even when an ad campaign is not on target to reach its cap, if for instance the advertiser has set additional caps for individual ads within the campaign, and if all ads that are suitable for being displayed in an available spot have already reached their individual cap. In such an instance, the ADSP enables standby content that is appropriate for being displayed in the available spot for inclusion in the list reported back to game instance, rather than accept the financial liability or lost revenue of allowing the spot to remain empty or with unpaid content.

The game instance ultimately fetches the content, and as each spot gets presented, determines which piece of content to place in the spot, based on the client-side constraints associated with all the candidate content. During the game, the game instance enumerates the number of impressions made during the game session for each ad on a per user, per game, per session and/or per platform basis. At the some time, data relating to the number of impressions is communicated back to the ADSP and is used to update the local current impressions count. Optionally the data relating to the number of impressions is communicated back to the mediating broker.

Referring now to FIG. 2c, shown is a simplified flow diagram of another communication scheme for being implemented by the system of FIG. 2a. The advertising broker site 210 is in communication via WAN 200 with game 202 and with game 204. Game 202 and game 204 are each in communication with ADSP 206 and with ADSP 208 via WAN 200. Additionally, ADSP 206 and ADSP 208 are both in communication with the advertising broker site 210 via WAN 200. When a game instance of game 202 or 204 begins, that game instance communicates via WAN 200 with the advertising broker site 210 to determine from which of the plurality of ADSPs it is to retrieve content. The advertising broker site 210 communicates a response via WAN 200, including an indication of which of the plurality of ADSPs the game instance is required to contact for content. Subsequent to the initial “handshake” with the advertising broker site 210, the game instance communicates a content delivery request to one or more indicated ADSPs. Each ADSP that receives a content delivery request fetches from the advertising broker site 210 a current impressions count for each piece of content that is relevant to the game instance, and determines whether or not to include specific pieces of content in the list that is reported back to the game instance based on whether the campaign cap is or is about to be exceeded. This communication scheme relies upon the advertising broker site 210 maintaining current impressions counts for a plurality of ad campaigns that are distributed across a plurality of ADSPs. While the advertising broker site 210 does not per se determine the list of content that is provided to the game instance, nevertheless it is advantageous to centralize the reporting and aggregating of impression data in this way. For instance, a particular advertiser provides content that is to be distributed by a specific ADSP as part of a regular ad campaign. The advertiser now has the option of specifying that this content and/or additional stand-by content is to be made available to other ADSPs as “emergency content,” on an occasional basis, in the event that one of the other ADSPs has no other revenue generating content available for display, and wishes to offer an available spot on a very short term basis at a deeply discounted rate. For instance, if all of the regular and standby content that is normally available to an ADSP has reached its cap, then the ADSP cannot charge the advertiser for additional impressions. According to the scheme that is shown in FIG. 2a and 2c, the ADSP has the choice of either offering “free” advertising to the regular advertiser or referring the game instance to another ADSP to obtain “emergency content.” The advertising broker site 210 optionally provides a list of “emergency content” whenever an ADSP requests a current impressions count, or only when the current impressions count for all of an ADSPs regular and standby content has reached its predetermined cap. Further optionally, the ADSP that is associated with the “emergency content” receives some form of remuneration when the “emergency content” is displayed, such as for instance a nominal finder's fee.

The current impression count that is maintained by the advertising broker site 210 is updated when a game instance communicates impression data to the advertising broker site 210. The impression data is communicated back to the advertising broker site 210 at a predetermined time. For instance, during a previous gaming session each instance of games 202 and 204 enumerates the number of impressions of specific pieces of content. At the time a new game instance is initiated, the game instance establishes communication via WAN 200 with the advertising broker site 210 and reports the impression data relating to the previous gaming session. The number of impressions is then aggregated at the broker level, across all instances of games 202 and 204. In this way, the advertising broker site 210 is able to maintain a current impressions count relating to all ad campaigns being implemented across a plurality of ADSPs, and/or relating to each piece of content within a particular ad campaign. Of course, optionally the impression data is communicated back to the advertising broker site 210 at a different predetermined time during which the game instance is connected to WAN 200. Some non-limiting examples include: during a current game instance after a predetermined number of impressions is served, during a current game instance after a predetermined amount of time has elapsed since a previous update was communicated, during a current game instance every time a gamer advances to a next level, during a current game instance any time the game is paused or suspended, during a current multi-player game instance whenever a new gamer joins, and at the end of a current game session prior to the game instance disconnecting from the WAN 200.

Another advantage that is realized by centralizing the tasks of reporting and aggregating impression data is that an independent analysis is performable on data relating to a plurality of different ADSPs. In this way, an advertiser optionally communicates with the advertising broker site 210 before committing to running an ad campaign with any particular ADSP. Based on historical data, the advertising broker site 210 optionally pairs the advertiser with an appropriate ADSP, subject to pricing or other criteria as specified by the advertiser.

Optionally, the advertising broker site 210 communicates directly with one or more appropriate ADSPs, so as to relay the initial request from a game instance rather than simply providing to the game instance an indication of which of the plurality of ADSPs the game instance is required to contact for content. This reduces the overall number of communication steps that are involved in providing content to the game instance.

Of course, there is still a variable lag between a game instance fetching content, generating impressions and subsequently reporting the impressions to the advertising broker site 210. This lag result in the campaign cap being exceeded at least some of the time, since the ADSP is not be aware that a cap has been met until all instances of a game session have reported their results, yet in the interim, the ADSP continues to provide content to new game instances. Advantageously, in some instances the advertising broker site 210 dynamically models this lag, which varies both by game and by time and date, and communicate a message to an appropriate ADSP when a campaign cap is about to be reached.

Optionally, client-side constraints also are used to limit the impression frequency for individual clients. Further optionally, client-side constraints are specified on one or more of a: per time interval basis, per game basis, per session basis, per gamer basis, and per platform basis. Client-side constraints are fetched by the game instance along with the content. The game instance then resolves multiple client-side constraints associated with multiple pieces of provided content to determine which content to present in a given spot at and at a given time. Optionally an advertiser specifies that a fixed percentage of impressions are to be made to a gamer client, or specifies that the impressions occur according a particular presentation schedule, both of which are also client-side constraints. Additionally, advertisers typically want to be assured that all impressions that are recorded are in fact impressions that are presented to actual gamers, as opposed to software (e.g., “bots”), which merely automatically invoke games and generate ad impressions. Client-side constraints help to mitigate this risk.

Advantageously, the current impressions count maintained by the advertising broker site 210 is useful for scheduling future impressions in order to maximize aggregate revenue and reduce financial liability relating to unfilled spots. One way to achieve these goals is to offer spots to additional advertisers on a standby basis. Standby content is used as a sort of filler material when regular ad campaign content is not available to fill a particular spot in a game instance. This is done for a number of different reasons. For instance, if an advertiser sets an impression cap for an ad campaign that is scheduled to run for three months and this cap is reached two weeks early, then the broker advertising site 210 enables standby content for inclusion in the list reported back to the ADSP. Optionally the standby impressions are offered on a break-even basis for the ADSP. If the impression frequency is higher than expected early in the ad campaign, then the ADSP optionally enables standby content for inclusion in the list reported back to game instance, to be interspersed with the regular content so as to stretch the same number of impressions over the entire duration of the ad campaign. The ADSP optionally begins interspersing small amounts of standby content early on in the ad campaign, or alternatively waits until the impression cap is nearly reached before interspersing a larger amount of standby content. Advertisers scheduling standby content optionally specifies that campaign caps associated with the content be satisfied before being available to additional other advertisers on a continued standby basis. Of course, standby content may still be provided even when an ad campaign is not on target to reach its cap, if for instance the advertiser has set additional caps for individual ads within the campaign, and if all ads that are suitable for being displayed in an available spot have already reached their individual cap. In such an instance, the ADSP enables standby content that is appropriate for being displayed in the available spot for inclusion in the list reported back to game instance, rather than accept the financial liability of allowing the spot to remain empty.

The game instance ultimately fetches the content from an ADSP, and as each spot gets presented, determines which piece of content to place in the spot, based on the client-side constraints associated with all the candidate content. During the game, the game instance enumerates the number of impressions made during the game session for each ad on a per user, per game, per session and/or per platform basis. At some time, data relating to the number of impressions is communicated back to the advertising broker site 210 and is used to update the local current impressions count. The submitted data is aggregated with all other client's data to keep track of the global and regional number of impressions served. Optionally, the data is provided upon terminating a gaming session, or upon re-initializing a new gaming session, and optionally includes an indication of which if any client-side constraints were met.

Referring again to FIGS. 2a-2c, in some instances an advertiser requires spots that are controlled by more than one ADSP to achieve a desired “reach” for an ad campaign. For instance a first ADSP “buys” a first block of spots for a first predetermined period of time and a second ADSP “buys” a second block of spots for a second predetermined period of time, the first and second predetermined periods of time overlapping with a time of the ad campaign. The advertiser wishes to display some of its content using at least a spot of the first block of spots and also wishes to display some of its content using at least a spot of the second block of spots. The advertising broker site 210 creates an aggregate campaign for the advertiser, such that spots from the first and second blocks of spots are available to the advertiser. Optionally, all of the advertiser's content is stored locally to only one of the first and second ADSPs. In this case, for instance, the first ADSP provides content to the game instance in response to a request, and the second ADSP provides a permission to display content from the first ADSP using a spot controlled by the second ADSP. Alternatively, the content is spread across the two ADSPs, and each ADSP provides content stored locally thereto in response to a request from the game instance. Further alternatively, content is cached locally to the game instance, and each ADSP provides a list of available content selected from the locally cached content, for display using a spot controlled by that ADSP. Since, in the current example, the advertiser's content is displayed using spots that are controlled by two ADSPs, it is advantageous that the advertising broker site 210 maintains a current impressions count relating to the aggregate ad campaign and optionally to specific ad content of the aggregate ad campaign. Absent the broker site 210, each ADSP is required to maintain a local impressions count. It is then necessary for communication to occur either between the two ADSPs, or between one the advertiser and the two ADSPs, to determine total impression counts for the ad campaign. Alternatively, the advertiser must settle for splitting the ad campaign and the associate ad campaign cap amongst the two separate ADSP. Unfortunately, it is likely that less than the total number of desired impressions are served in this manner, since if one ADSP fails to reach the cap set for it by the advertiser, then the additional capacity is not easily transferred to the other ADSP.

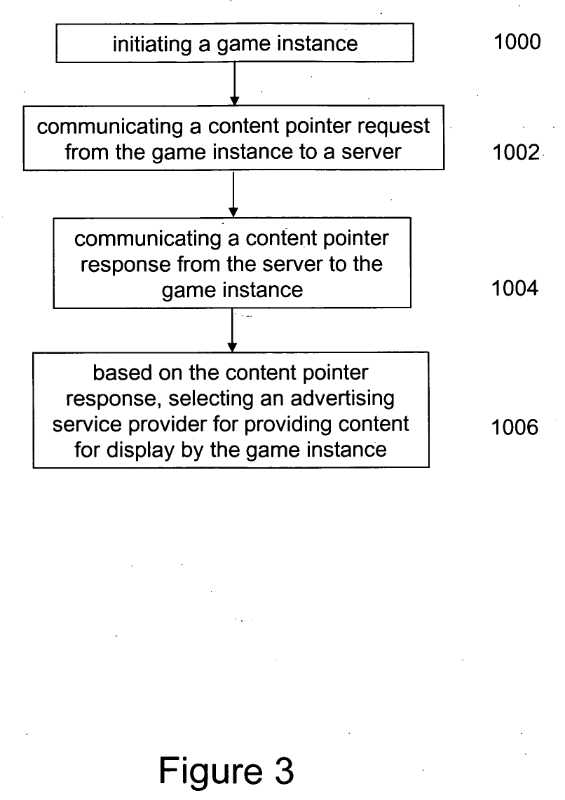

Referring now to FIG. 3, shown is a simplified flow diagram of a method for selecting an advertising service provider. At step 1000 a game instance is initiated. At step 1002 a content pointer request is communicated from the game instance to a server, such as for instance a server of an advertising broker site. At step 1004 a content pointer response is communicated from the server to the game instance. At step 1006 an advertising service provider is selected for providing content for display by the game instance, based on the content pointer response.

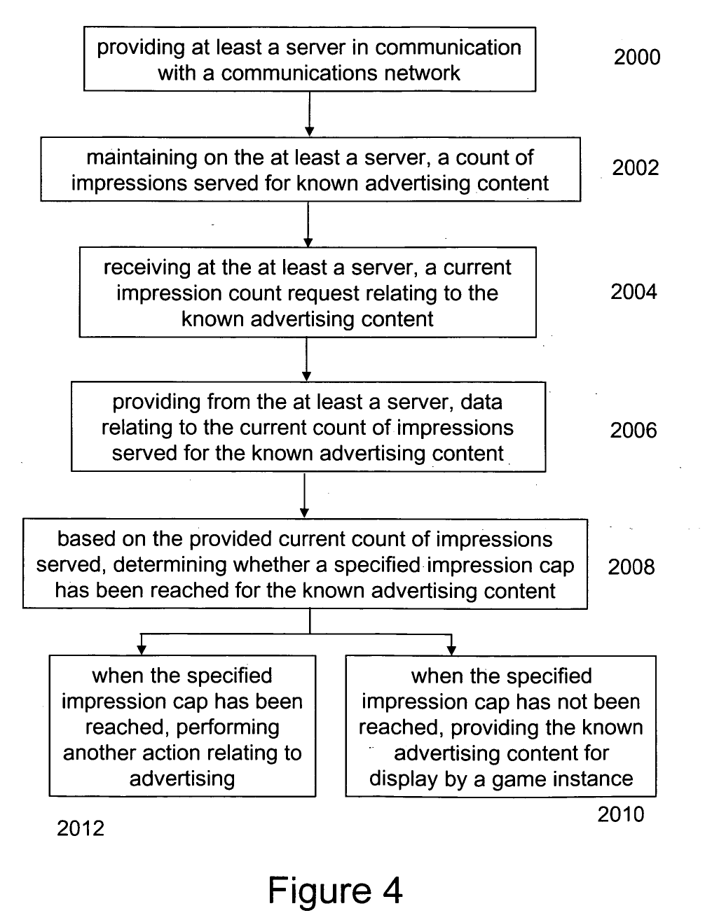

Referring now to FIG. 4, shown is a simplified flow diagram of a method according to an embodiment of the instant invention. At step 2000 at least a server, for instance a server of an advertising broker site, is provided in communication with a communications network such as for instance a wide area network. Step 2002 is a step of maintaining, on the at least a server, a count of impressions served for known advertising content. At step 2004 a current impression count request relating to the known advertising content is received at the at least a server. At step 2006 data relating to a current count of impressions served for the known advertising content is provided from the from the at least a server. Based on the provided current count of impressions served for the known advertising content, a determination is made at step 2008 whether a specified impression cap has been reached for the known advertising content.

According to the method described with reference to FIG. 4, when the specified impression cap has not been reached, then the specific content is provided for display by a game instance at optional step 2010. When the specified impression cap has been reached, then another action relating to advertising is performed as indicated at optional step 2012. Some non-limiting examples of other actions include providing standby content for display by a game instance and providing a referral to “emergency content” that is relevant to the game instance.

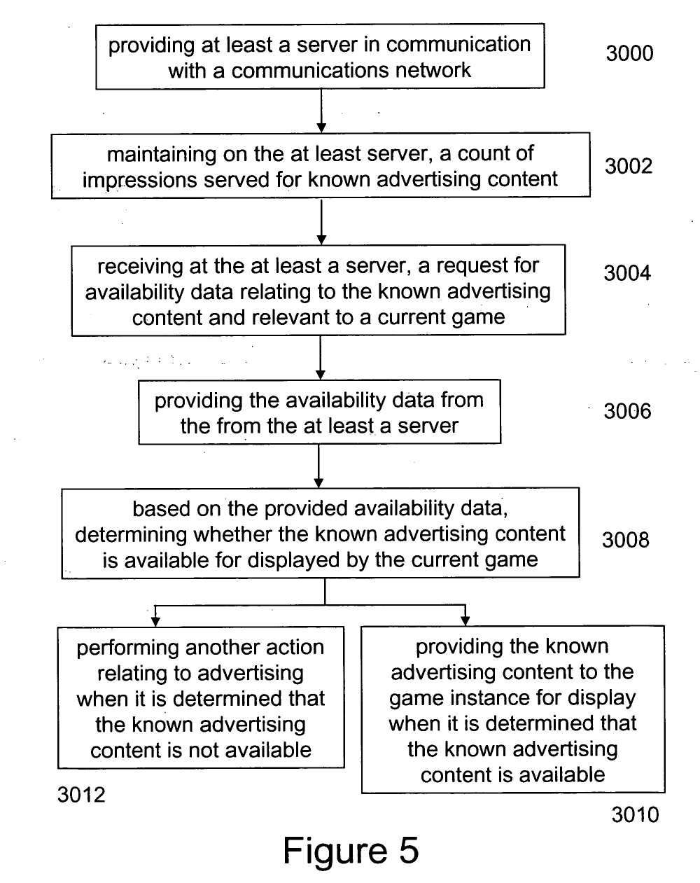

Referring now to FIG. 5, shown is a simplified flow diagram of another method according to an embodiment of the instant invention. At step 3000 at least a server, for instance a server of an advertising broker site, is provided in communication with a communications network, such as for instance a wide area network. Step 3002 is a step of maintaining, on the at least a server, a count of impressions served for known advertising content. At step 3004 a request is received at the at least a server for availability data relating to the known advertising content and relevant to a current game. At step 3006 the availability data is provided from the at least a server. The availability data is optionally an indication that the known advertising content is or is not available, or simply a value representative of the count of impressions served for the known advertising content or related ad campaign. At step 3008, based on the provided availability data, a determination is made whether the known advertising content is available to be displayed by the current game.

If it is determined that the known advertising content is available, then the known advertising content is provided to the current game at optional step 3010 for display. If it is determined that the relevant content is not available, then an action relating to advertising is performed at optional step 3012 without providing the known advertising content to the current game for display. Some non-limiting examples of other actions include providing standby content for display by the current game and providing a referral to “emergency content” that is relevant to the current game. The count of impressions served is updated at predetermined times when the current game provides a report of additional impressions served. For instance, during a previous gaming session the current game enumerates the number of impressions served. At the time a new game instance is initiated, the current game establishes communication via the wide area network with the at least a server and reports impression data relating to the previous gaming session.

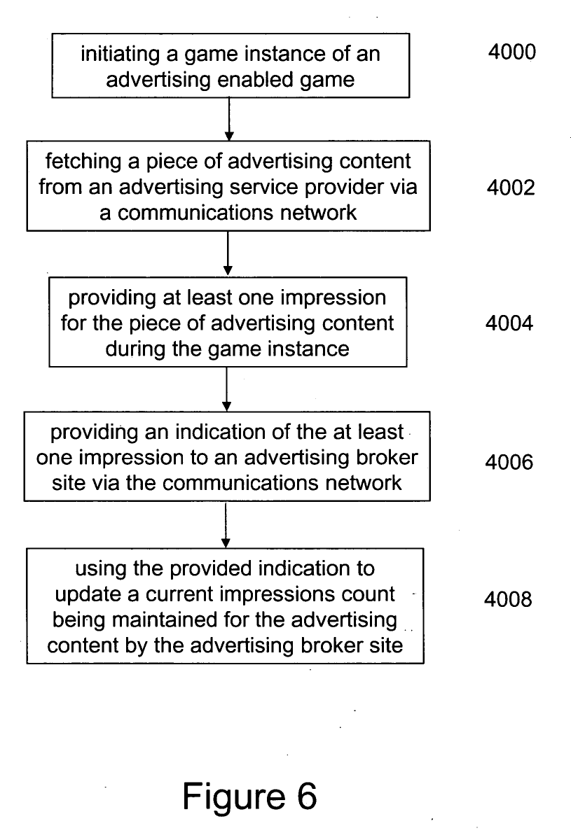

Referring now to FIG. 6, shown is a simplified flow diagram of yet another method according to an embodiment of the instant invention. At step 4000 a game instance of an advertising enabled game is initiated. At step 4002 a piece of advertising content is fetched from an advertising service provider via a communications network, such as for instance a wide area network (WAN). At step 4004 at least one impression is provided for the piece of advertising content during the game instance. At step 4006 an indication of the at least one impression is provided to an advertising broker site via the communications network. At step 4008 the provided indication is used to update a current impressions count being maintained for the advertising content by the advertising broker site. The indication of the at least one impression is provided at predetermined times. For instance, during a previous gaming session the game instance enumerates the number of impressions served. At the time the new game instance is initiated at step 4000, the game instance establishes communication via the wide area network with the advertising broker site and provides the indication of the at least one impression for the previous gaming session. The current impressions count is then updated at step 4008, discussed supra.

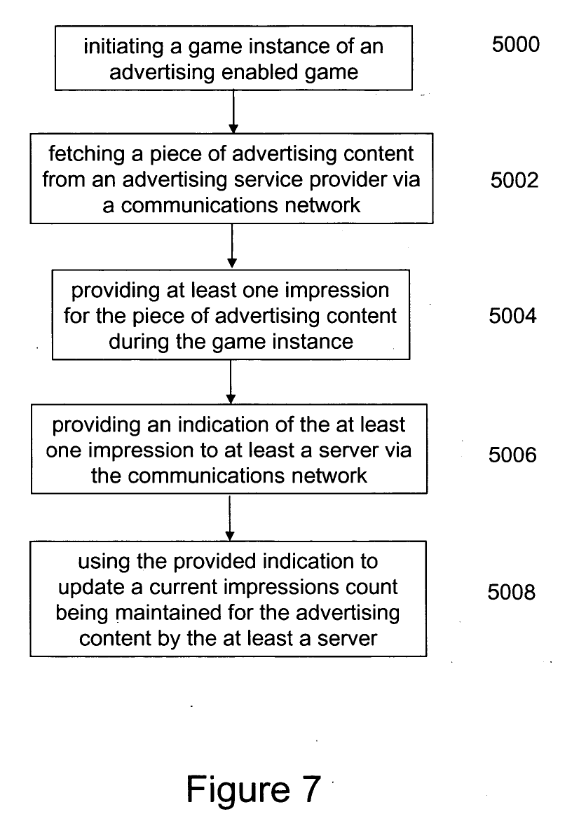

Referring now to FIG. 7, shown is a simplified flow diagram of a method according to still another embodiment of the instant invention. At step 5000 a game instance of an advertising enabled game is initiated. At step 5002, a piece of advertising content is fetched from an advertising service provider (ADSP) via a communications network, such as for instance a wide area network (WAN). At step 5004, at least one impression is provided for the piece of advertising content during the game instance. At a time, an indication of the at least one impression is provided at step 5006 from the game instance to at least a server via the communications network. At step 5008, and based on the provided indication, a current impressions count being maintained for the piece of advertising content on the at least a server is updated.

Optionally, content is stored at a remote location such as an ADSP and provided to a game instance upon request, via a wide area network. The time that is required for the game instance to obtain content varies in dependence upon the size of the content file, network traffic loads, network problems, number of files requested, etc. Accordingly, optionally the content for an ad campaign is cached locally to the game instance, such as for instance using a local storage medium such as a hard disk drive of a computer system that is used to run the game instance. Advantageously, new content is provided via the wide area network only at the start of each new campaign, and then is retrieved from a local storage medium for display during game instances occurring within the time limitations of that campaign. Optionally, updated content is provided throughout an ad campaign, as it becomes available for either replacing or supplementing the original content. Advantageously, retrieving locally cached content from a local storage medium requires less time than fetching the same content via a Wide area network. When the content is cached locally, then a request for available content sent to an ADSP from a game instance preferably includes a list of currently cached content, and is answered with a list of available content selected from the currently cached content, and/or updated or supplemental content, if available and if not already cached locally to the game instance.

Numerous other embodiments may be envisaged without departing from the spirit and scope of the instant invention. All specific examples have been provided for illustrative purposes only and are not intended to be limiting in any way.

What is claimed is:

1. A method for managing advertising content delivery in a gaming environment, comprising:
providing at least a server connected to a communications network;
maintaining on the at least a server a count of impressions served for known advertising content;
receiving at the at least a server a current impression count request, the request relating to the known advertising content;
providing from the at least a server, data relating to a current count of impressions served for the known advertising content; and,
based on the provided current count of impressions served, determining whether a specified impression cap has been reached for the known advertising content.

2. A method according to claim 1, wherein the at least a server is a server of an advertising broker site.

3. A method according to claim 2, wherein the current impression count request originates at a computer system of an advertising service provider (ADSP), the computer system in communication with the server of the advertising broker site via the communications network.

4. A method according to claim 2, wherein the current impression count request originates at a computer system of an advertising agency, the computer system in communication with the server of the advertising broker site via the communications network.

5. A method according to claim 2, wherein the current impression count request originates at a computer system of an advertiser, the computer system in communication with the server of the advertising broker site via the communications network.

6. A method according to claim 1, wherein the at least a server is a server of an advertising service provider (ADSP).

7. A method according to claim 6, wherein the current impression count request originates at a computer system of an advertising agency, the computer system in communication with the server of the ADSP via the communications network.

8. A method according to claim 6, wherein the current impression count request originates at a computer system of an advertiser, the computer system in communication with the server of the ADSP via the communications network.

9. A method according to claim 1, wherein determining whether a specified impression cap has been reached for the known advertising content comprises making a statistical determination based upon the provided current count of impressions served and other data relating to a historical impression frequency of the known advertising content.

10. A method according to claim 1, comprising making the known advertising content available for display by a game instance within an approved advertising spot, when it is determined that the specified impression cap has not been reached.

11. A method according to claim 3, comprising making the known advertising content available for display by a game instance within an approved advertising spot, when it is determined that the specified impression cap has not been reached.

12. A method according to claim 11, wherein making the known advertising content available comprises, providing data relating to the known advertising content from the ADSP to the game instance, via the communications network.

13. A method according to claim 12, wherein providing data comprises providing a file including code for rendering the known advertising content within the game instance.

14. A method according to claim 12, wherein providing data comprises providing a permission for allowing the game instance to display the known advertising content from a cached file local to the game instance.

15. A method according to claim 12, comprising displaying the known advertising content within the approved spot.

16. A method according to claim 15, comprising enumerating an additional impression for the known advertising content when the known advertising content is displayed in the approved spot.

17. A method according to claim 16, comprising providing data indicative of the enumerated additional impression from the game instance to the server of the advertising broker site, via the communications network.

18. A method according to claim 17, comprising updating the count of impressions served maintained on the server of the advertising broker site, for the known advertising content and based upon the provided data indicative of the enumerated additional impression.

19. A method according to claim 17, wherein the data indicative of the enumerated additional impression relates to an impression during a previous gaming session, and wherein the data indicative of the enumerated additional impression is provided to the server of the advertising broker site during an initialization process of a next gaming session.

20. A method according to claim 1, comprising providing standby content for display by a game instance within an approved advertising spot when it is determined that the specified impression cap has been reached, the standby content not including the known advertising content.

21. A method according to claim 1, wherein the specified impression cap relates to impressions of the known advertising content served.

22. A method according to claim 1, wherein the known advertising content is a portion of an ad campaign, the ad campaign including other content in addition to the known advertising content.

23. A method according to claim 22, wherein the specified impression cap relates only to a number of impressions of the known advertising content served.

24. A method according to claim 22, wherein the specified impression cap relates to a number of impressions of the known advertising content served plus a number of impressions of the other content served.

25. A method for managing advertising content delivery in an gaming environment, comprising:
providing at least a server connected to a communications network;
maintaining on the at least a server a count of impressions served for known advertising content;
receiving at the at least a server a request for availability data relating to the known content and relevant to a current game;
providing from the at least a server the availability data; and,
based on the provided availability data, determining whether the known advertising content is available to be displayed by the current game.

26. A method according to claim 25, wherein the at least a server is a server of an advertising broker site.

27. A method according to claim 26, wherein the request for availability data originates at a computer system of an advertising service provider (ADSP), the computer system in communication with the server of the advertising broker site via the communications network.

28. A method according to claim 26, wherein the request for availability data originates at a computer system of an advertising agency, the computer system in communication with the server of the advertising broker site via the communications network.

29. A method according to claim 26, wherein the request for availability data originates at a computer system of an advertiser, the computer system in communication with the server of the advertising broker site via the communications network.

30. A method according to claim 25, wherein the at least a server is a server of an advertising service provider (ADSP).

31. A method according to claim 30, wherein the request for availability data originates at a computer system of an advertising agency, the computer system in communication with the server of the ADSP via the communications network.

32. A method according to claim 30, wherein the request for availability data originates at a computer system of an advertiser, the computer system in communication with the server of the ADSP via the communications network.

33. A method according to claim 25, wherein the availability data comprises an indication that the known advertising content is one of available and not available for display by the current game.

34. A method according to claim 25, wherein the availability data comprises a value that is representative of a current count of impressions served for the known advertising content.

35. A method according to claim 34, wherein determining whether the known advertising content is available to be displayed by the current game comprises comparing the value that is representative of a current count of impressions served to a specified impressions cap.

36. A method according to claim 35, wherein the specified impression cap relates to impressions of the known advertising content served.

37. A method according to claim 35, wherein the known advertising content is a portion of an ad campaign, the ad campaign including other content in addition to the known advertising content.

38. A method according to claim 37, wherein the specified impression cap relates only to a number of impressions of the known advertising content served.

39. A method according to claim 37, wherein the specified impression cap relates to a number of impressions of the known advertising content served plus a number of impressions of the other content served.

40. A method according to claim 27, comprising making the known advertising content available for display by the current game within an approved advertising spot, when it is determined that the known advertising content is available to be displayed by the current game.

41. A method according to claim 40, wherein making the known advertising content available comprises, providing data relating to the known advertising content from the ADSP to the current game, via the communications network.

42. A method according to claim 41, wherein providing data comprises providing a file including code for rendering the relevant content within the current game.

43. A method according to claim 41, wherein providing data comprises providing a permission for allowing the current game to display the known advertising content from a cached file local to the current game.

44. A method according to claim 41, comprising displaying the known advertising content within the approved spot.

45. A method according to claim 44, comprising enumerating an additional impression for the known advertising content when the known advertising content is displayed in the approved spot.

46. A method according to claim 45, comprising providing data indicative of the enumerated additional impression from the current game to the server of the advertising broker site, via the communications network.

47. A method according to claim 46, comprising updating the count of impressions served maintained on the server of the advertising broker site, for the known advertising content and based upon the provided data indicative of the enumerated additional impression.

48. A method according to claim 47, wherein the data indicative of the enumerated additional impression relates to an impression during a previous gaming session, and wherein the data indicative of the enumerated additional impression is provided to the server of the advertising broker site during an initialization process of a next gaming session.

49. A method according to claim 25, comprising providing standby content for display by the current game within an approved advertising spot when it is determined that the known advertising content is not available to be displayed by the current game, the standby content not including the known advertising content.

50. A method for managing advertising content delivery in an gaming environment, comprising:
initiating a game instance of an advertising enabled game;
retrieving a piece of advertising content from an advertising service provider (ADSP) via a communications network;
providing at least one impression for the piece of advertising content during a game instance;
at a time, providing an indication of the at least one impression from the game instance to an advertising broker site via the communications network;
based on the provided indication, updating a current impressions count being maintained for the piece of advertising content by the advertising broker site.

51. A method according to claim 50, wherein the time occurs during an initialization process of a current gaming session, and wherein the indication of the at least one impression relates to impressions that were provided during a previous gaming session.

52. A method according to claim 50, wherein the piece of advertising content is part of an advertising campaign, and wherein the updated current impressions count is aggregated with updated current impressions counts that are being maintained for other content of the advertising campaign, so as to obtain an updated current impressions count for the advertising campaign.

53. A method according to claim 52, comprising providing from the advertising broker site to the ADSP via the communications network, data that is indicative of at least one of the updated current impressions count for the piece of advertising content and the updated current impressions count for the advertising campaign.

54. A method according to claim 53, wherein the data provided from the advertising broker site to the ADSP is used by the ADSP to determine in response to a subsequent request from the game instance, whether to provide the piece of advertising content.

55. A method according to claim 54, wherein determining comprises comparing the at least one of the updated current impressions count for the piece of advertising content and the updated current impressions count for the advertising campaign to a known cap value.

56. A system for managing advertising content delivery in a gaming environment that is in execution on an online enabled platform, the gaming environment including a plurality of game instances each containing therein spots for displaying advertising content, the system comprising:
a plurality of advertising service providers (ADSPs) each for communicating with a plurality of game instances via the communications network, the ADSPs for making advertising content available for display at spots within the plurality of game instances, the advertising content having predetermined availability characteristics; and, p1 an advertising broker site in communication with the plurality of game instances and with the plurality of ADSPs via the communications network, the advertising broker site for storing data that is relevant to the predetermined availability characteristics of the advertising content, and for updating the stored data based on usage reports provided from the plurality of game instances via the communications network.
